(19) United States
(12) Patent Application Publication
(10) Pub. No.: US 2007/0202588 A1
(43) Pub. Date: Aug. 30, 2007

(54) Petroleum Biosorbent Based on Strains of Bacteria and Yeast

(76) Inventors: Fluza Mubarakovna Khabibullina, Siktivkar (RU); Inna Borisovna Archegova, Siktivkar (RU); Anatoli Alexandrovich Shubakov, Siktivkar (RU); Irina Ednundovna Sharapova, Siktivkar (RU); Gennady Grigorievich Romanov, Siktivkar (RU); Ivan Yurievich Chernov, Moscow (RU); Anatoly Ivanovich Taskaev, Siktivkar (RU); Gennady Mikhailovich Tuliankin, Kirov (RU); Yuriy Sergeevich Zhuchikhin, Kirov (RU); Anatoly Nikolaevich Kozminikh, Kirov (RU)

Correspondence Address: UNITED STATES DEPARTMENT OF ENERGY, 1000 INDEPENDENCE AVENUE, S.W., ATTN: GC-62 (HQ) MS 6F-067, WASHINGTON, DC, 20585-0162, US

(21) Appl. No.: 11/673,590

(22) Filed: Feb. 11, 2007

(30) Foreign Application Priority Data
Feb. 11, 2006 (RU) 2006104082/13

(51) Int. Cl. A62D 3/02; A62D 101/20

(52) U.S. Cl. 435/262.5

(57) ABSTRACT

This invention relates to biosorbents used for clean-up of petroleum-based contamination of water. The invention can be used for clean-up of natural and artificial water reservoirs, sewers, and liquid waste that is contaminated with petroleum and petroleum products. The invention absorbs petroleum-based contamination and degrades it using strains of bacteria, yeast, or a consortium thereof. The desired microbe stains are immobilized on a hydrophobic sorbent, which is placed on the surface of the water to be decontaminated. The biosorbent is allowed to sit on the water surface for a period of time to allow for microbial degradation of the petroleum.

### CROSS-REFERENCE TO A RELATED APPLICATION

The invention described and claimed hereinbelow is also described in Patent Application 2006104082/13 filed on Feb. 10, 2006 in the Russian Federation. This Patent Application, whose subject matter is incorporated herein by reference, provides the basis for a claim of priority of invention under 35U.S.C. 119(a)-(d).

### BACKGROUND OF THE INVENTION

The present invention relates to the petroleum industry and ecology and can be used for the cleaning of contaminated surfaces of natural and artificial water reservoirs, sewages and liquid wastes, where water is contaminated with petroleum and petroleum products.

Hydrophobic sorbents based on peat are known (patents of Russian Federation no. 2116128, no. 2191067, no. 2201898, patent application no. 2003127857). All hydrophobic sorbents are characterized by high petroleum absorption ability and ability to float on the surface of water.

Hydrophobic organomineral petroleum sorbent “SORBONAFT” is known (Tu 0392-001-55763877-2003). The sorbent is produced in accordance with a method described in a patent of the Russian Federation no. 2114859. Maximum absorption ability of the sorbent is 650%, with the size of the particles of the particulate sorbent in the range of 0.2-3.0 mm. This sorbent has the disadvantage that the petroleum collected from the water surface must be either separated from the sorbent which involves additional expenses, or the sorbent must be utilized together with petroleum, which is economically not profitable.

Sorbent NAFTOKS is known for purification of soil and water from petroleum and petroleum products (patent of Russian Federation no. 2053205), which was selected by us as a prototype, and includes aerobic petroleum oxidizing bacteria, taken in an efficient quantity, and a filler in form of organic or mineral solid substrate, for example peat, turf-podzol soil, black earth, peat-manure compost. The disadvantage of this biopreparation is that the used substrate does not have hydrophobicity on the surface of water.

The objective of the invention is to obtain a biosorbent, which is capable of performing sorption and biodegradation of petroleum and petroleum products from a water surface due to the use of microorganisms, which may be immobilized on a hydrophobic sorbent and are characterized by high biodestruction activity during liquidation of intense (more than 40% petroleum) contaminations.

### SUMMARY OF THE INVENTION

Accordingly, it is an object of the present invention to provide a biosorbent for petroleum products based on strains of bacteria and yeast fungi, that are capable of sorption and biodegradation of petroleum and petroleum products from a water surface, where the microorganisms may be immobilized on a hydrophobic sorbent, and where the biosorbent is characterized by high biodestruction activity during liquidation of intense (more than 40% petroleum) contaminations.

In keeping with these objects and with others which will become apparent hereinafter, one feature of the present invention resides, briefly stated, in a biosorbent for purification of a water surface from petroleum and petroleum products that includes petroleum-oxidizing microorganisms which are used in an effective amount, and a carrier, and characterized in that the carrier contains a hydrophobic petroleum sorbent based on peat. The petroleum-oxidizing microorganisms include strains of bacteria, preferably, Rhodococcus erythropolis, Arthrobacter sp.; or yeast fungi such as Candida lipolytica, Candida guillermondii, Pichia guillermondii; or a bacteria-yeast consortium. The microorganisms are immobilized on the petroleum sorbent to form a biosorbent such that the microorganisms reach a preferred concentration of 20-30% of the mass of the biosorbent.

The novel features of the present invention are presented in the accompanying claims, while the detailed description of the present invention is presented herein below.

### DESCRIPTION WITH THE PREFERRED EMBODIMENTS

In accordance with the present invention, a biosorbent for purification of water reservoirs from petroleum products, including petroleum-oxidizing microorganisms taken in effective amount, and a carrier, comprising a hydrophobic petroleum sorbent based on peat, and petroleum-oxidizing microorganisms, preferably comprising bacteria such as Rhodococcus erythropolis, Arthrobacter sp.; or yeast fungi such as Candida lipolytica, Candida guillermondii, Pichia guillermondii, or a bacteria-yeast consortium immobilized on the petroleum sorbent to form a biosorbent such that the microorganisms reach a preferred concentration of 20-30% of the mass of the biosorbent.

The strains of the bacteria Rhodococcus erythropolis, Arthrobacter sp. and yeast fungi Candida lipolytica, Candida guillermondii, and Pichia guillermondii are stored in a collection of the Institute of Biology I of the Komi Science Center of the Ural Department of the Russian Academy of Sciences. Yeast cultures are also stored in the Faculty of Soil Biology of the Department of Soil Science of the Moscow State University named after M. V. Lomonosov.

The inventors gave the following identifications to the strains and fungi:

1. Rhodococcus erythropolis —NK-16;

2. Arthrobacter sp—NK-15

3. Candida lipolytica—KBP-3308

4. Candida guillermondii—KBP-3175;

5. Pichia guillermondii—KBP-3205.

The strains of microorganisms are obtained by their separation from petroleum products and petroleum-contaminated substrates on nutrient media by means of alternation of accumulating and cup cultures with a mandatory testing of purity (Litvinenko S. N. Protection of Petroleum Products from Action of Microorganisms, M. Publisher “Chemistry”, 1977). For separation of cultures of microorganisms, a medium with the following composition can be used: KH₂PO₄-2.5; NH₄NO₃-5.0; MgSO₄×7H₂O-1.0; H₂O-1 L, and petroleum-5.0 g. In the case of solid nutrient media, 20 g of agar for 1 L of medium is added.

The microorganisms and their consortia as well as the biosorbent as a whole, are characterized as ecologically non-toxic. Experimental evaluation of a degree of danger of the preparations was carried out in accordance with “Criteria of Placing of Dangerous Wastes to a Class of Danger for Environmental Natural Medium”, approved by Order of MPR of Russia of Jun. 15, 2001, no. 511. The obtained results are confirmed by two standard methods of biotesting with the use of daphnia (“Determination of Toxicity of Water and Water Samples from Soils, Precipitations of Sewages, Wastes Based on Depth and Change of Fertility of Dafnii Daphnia Magna”, FR 1.1.39.2001-00-283) and Seaweeds (“Determination of Toxicity of Water and Water Samples from Soil, Precipitation of Sewage, Wastes Based on Change of Level of Fluorescence of Chlorophyll and Number of Cells of Seaweeds Scenedesmus Quadricauda “FR 1.1.39.2001-00-284). The tests were conducted in an accredited laboratory of ecotoxicological analysis of soils of Department of Soil Science of Moscow State University (LETAP) (Certificate of Accreditation No. POCC RU.0001.513050).

Rhodococcus erythropolis (NK-16) was obtained by selection from natural samples of petroleum-containing soils in the 203th well of the Usin region of the Republic of Komi. It is identified by the Institute of Biochemistry and Physiology of Microorganisms named after G. K. Skriabin 13.04.01. Rhodococcus erythropolis are Gram-positive bacteria which form mucous colonies of creme color on the majority of nutrient media. In young cultures, straight and slightly curved branching rods are predominant, which with age disintegrate to coccus-like shapes.

Arthrobacter sp. (NK-15) was separated from petroleum-contaminated soil in 203th well of the Usin region of the Republic of Komi in 1999. Arthrobacter sp. are Gram-negative aerobic rod-shaped bacteria, forming mucous round colonies of creme color on MPA media.

The Candida guillermondii (KBP-3176; NK-302) was from a collection of microorganisms of the Faculty of Soil Biology of the Department of Soil Science of Moscow State University named after M. V. Lomonosov. It was separated in the Scientific Research Institute of Genetics of Industrial Microorganisms in 1990 from aromatic hydrocarbons. Colonies on a medium of must are smooth, gray-white, small grains.

The Pichia guillermondii (KBP-3205; NK-303) was from a collection of microorganisms of Faculty of Soil Biology of the Department of Soil Science of Moscow State University named after M. V. Lomonosov, separated in 1982 from adult mosquitoes, Aedes diantaeus, in the Tomsk region.

The Candida lipolytica (KBP-3308; NK-304, anamopha-16), also known as Yarrowia lipolytica, was from the collection of Faculty of Soil Biology of the Department of Soil Science of the Moscow State University named after M. V. Lomonosov, separated in 1992 from stratum waters of the Bonduzh petroleum deposit. Colonies grown on a medium of must are smooth, gray-white, small grains.

The method for producing the biosorbent includes immobilization on petroleum hydrophobic sorbent of yeast fungi, preferably, Candida lipolytica, Candida guillermondii, Pichia guillermondii, or cultures of bacteria Rhodococcus erythropolis, Arthrobacter sp., or yeast-bacteria consortium, in the quantity from 10 to 50% (dry weight) with a subsequent drying in air. The biosorbent that contains not less than 20% of microorganisms is applied on a petroleum-contaminated water surface, and during this process a simultaneous biodegredation of adsorbed petroleum by bacteria-yeast association is carried out.

The method of producing the biosorbent and the properties of the obtained biosorbent are illustrated by examples. For the hydrophobic petroleum sorbent based on peat, the sorbent with trade names “SORBONAFT” was used.

In an experiment, immobilization of microorganisms into a petroleum sorbent was carried out, and after placement of the biosorbent on the petroleum contaminated water surface, the degree of destruction of the petroleum adsorbed by the biosorbent was determined.

In laboratory conditions, tests of the biosorbent were carried out with the goal of optimization of the process of degradation of petroleum on contaminated water surfaces. In accordance with this objective, in a first part of the test, the sorbent was enriched with microorganisms, and in the second part the produced biosorbent was sprayed on a water surface with a certain quantity of petroleum placed on it.

I. Into the bottom of small vessels (chutes), 20 ml of nutrient medium was poured (15% of non-alcoholized beer must), 20 g of sorbent “SORBONAFT” was placed into the chute, and then 20 ml of culture of microorganisms was distributed on top. Then, the chutes were placed into small polyethylene bags for reduction of moisture evaporation. Growth of microorganisms was carried out during nine days.

The following microorganisms were utilized:

1. Pichia guillermondii;

2. Candida lipolytica;

3. Candida guillermondii;

4. Rhodococcus erythropolis;

5. Arthrobacter sp.;

6. Consortium of Pichia guillermondii, Candida lipolytica, Candida guillermondii, Rhodococcus erythropolis, and Arthrobacter sp.

There were no outside indications of change of a sorbent mass, while some density increase of the sorbent mass could be noticed. In nine days the second part of the test was carried out.

II. In caps having a diameter of 19 cm, water was poured, with a distance from an edge to a water level of 1.5-2 cm. On the surface of the water, petroleum was poured, and then samples of biosorbents were distributed. Petroleum was sorbed during several minutes. Initial content of petroleum was 46%. After 27 days of the test, from the surface of water, the biosorbent was collected and placed into chutes for drying and further analysis.

Biodegredation of petroleum takes place due to the bioactivity of the microorganisms. Determination of remaining petroleum in the sorbent showed that after two weeks of the test, bacteria (Rhodococcus erythropolis, Arthrobacter sp.) and yeast fungi (Candida lipolytica, Candida guillermondii, Pichia guillermondii) contributed to destruction of petroleum, decreasing the contamination by 31.5% (with the use of Candida lipolytica), and by 30% (with the use of Candida guillermondii or Pichia guillermondii), and by 35% and 33% in the variants with Rhodococcus erythropolis and Arthrobacter sp.

The experiment was repeated with a consortium (association) of the above mentioned microorganisms (Rhodococcus erythropolis, Arthrobacter sp., Candida lipolytica, Candida guillermondii, and Pichia guillermondii). During the nine days the biosorbent was actively grown with fungi, the presence of mycelium was noted. Petroleum was poured into caps with a diameter of 19 cm on the surface of water, and samples of sorbents with microorganisms were distributed on the surface. Petroleum was sorbed for about 1 hour. After 27 days of the experiment, the sorbent was collected from the surface of water and placed into chutes for drying and further analysis. Table 1 shows chemical properties of the biosorbent after the biological transformation of petroleum contamination.

TABLE 1

| | | Chemical Characteristics | | | |
|---|---|---|---|---|---|
| | | of Biosorbent | | | |
| | | Nitrogen | | | Petroleum |
| | | hydroliz. | Phosphorus | Potassium | decrease, |
| Variant | pH | Mg for 100 g air dry weight | | | % |
| Candida | 4.59 | 8.4 | 7.6 | 14.8 | 31.5 |
| lipolytica | | | | | |
| Candida | 6.70 | 6.9 | 6.8 | 12.8 | 30.0 |
| guillermondii | | | | | |
| Pichia | 6.74 | 6.4 | 6.1 | 12.3 | 30.0 |
| guillermondii | | | | | |
| Rhodococcus | 6.10 | 7.0 | 7.2 | 17.9 | 35.0 |
| erythropolis | | | | | |
| Arthrobacter | 6.00 | 6.8 | 7.5 | 16.9 | 33.0 |
| sp. | | | | | |
| Consortium | 6.36 | 7.0 | 2.6 | 10.6 | 41.0 |
| of Candida | | | | | |
| lipolytica, | | | | | |
| Candida | | | | | |
| guillermondii, | | | | | |
| Pichia | | | | | |
| guillermondii, | | | | | |
| Arthrobacter | | | | | |
| sp., and | | | | | |
| Rhodococcus | | | | | |
| erythropolis | | | | | |

As can be seen from Table 1, noticeable (by 30-41%) decrease of level of contamination of biosorbents with petroleum took place, both with preparations based on monocultures of microorganisms and with their associations. During the 27-day test, the level of contamination in the biosorbent with the use of a consortium of microorganisms including Candida lipolytica, Candida guillermondii, Pichia guillermondii, Arthrobacter sp., and Rhodococcus erythropolis, was decreased by 41%. Noticeable accumulation in the sorbent of the elements nitrogen, phosphorus, and potassium, was connected with destruction of petroleum contamination and the bioactivity of microorganisms.

After the end of the test, in order to determine the quantity of microorganisms, samples of water under the sorbent, and of the sorbent itself, that remains on the water surface were taken. The quantity of microorganisms in water under the sorbent was insignificant, and in the sorbent there was a complete growth, leads to a conclusion about a relatively firm fixation of the yeast fungi and bacteria on the sorbent contaminated with petroleum, and therefore about the possibility of their use for destruction of petroleum collected by the sorbent on the water surface.

Subsequent experimental-production examination of adsorption and petroleum-destruction ability of the biopreparation in field conditions (on water petroleum-contaminated water surface in the Usin Region of the Republic of Komi) showed high sorption ability. The concentration was one part of the biopreparation: 6 parts of petroleum, which produced noticeable (by 51%) decrease of level of contamination of petroleum in the biosorbent during the vegetation period. Therefore, the biosorbent is capable of performing simultaneously the sorption and the biodegradation of petroleum and petroleum products from the water surface, due to the use of strains of bacteria, yeast, and consortium thereof, which are capable of being immobilized on a hydrophobic sorbent.

It will be understood that each of the elements described above, or two or more together, may also find a useful application in other types of products and methods differing from the type described above.

While the invention has been illustrated and described as embodied in a biosorbent for and method of purification of water from petroleum products based on strains of bacteria and yeast fungi, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

We claim:

1. A biosorbent that absorbs and biodegrades petroleum-containing substances in water, comprising a hydrophobic petroleum sorbent onto which petroleum-degrading microbes are immobilized.

2. The biosorbent of claim 1, wherein said hydrophobic petroleum sorbent comprises peat.

3. The biosorbent of claim 1, wherein said petroleum-degrading microbes comprise at least 20% of the mass of said biosorbent.

4. The biosorbent of claim 1, wherein said petroleum-degrading microbes comprise between 20% and 30% of the mass of said biosorbent.

5. The biosorbent of claim 1, wherein said petroleum-degrading microbes comprise Rhodococcus erythropolis.

6. The biosorbent of claim 1, wherein said petroleum-degrading microbes comprise Arthrobacter sp.

7. The biosorbent of claim 1, wherein said petroleum-degrading microbes comprise Candida lipolytica.

8. The biosorbent of claim 1, wherein said petroleum-degrading microbes comprise Candida guillermondii.

9. The biosorbent of claim 1, wherein said petroleum-degrading microbes comprise Pichia guillermondii.

10. The biosorbent of claim 1, wherein said petroleum-degrading microbes comprise a consortium of microbes selected from the group consisting of Rhodococcus erythropolis, Arthrobacter sp., Candida lipolytica, Candida guillermondii, and Pichia guillermondii.
